(19) United States
(12) Patent Application Publication
(10) Pub. No.: US 2024/0161052 A1
(43) Pub. Date: May 16, 2024

(54) INFORMATION PROVISION SYSTEM, INFORMATION PROVISION METHOD, AND RECORDING MEDIUM

(71) Applicant: NEC Corporation, Minato-ku, Tokyo (JP)

(72) Inventors: Ayano TAMURA, Tokyo (JP); Katsufumi TANAKA, Tokyo (JP)

(73) Assignee: NEC Corporation, Minato-ku, Tokyo (JP)

(21) Appl. No.: 18/280,616

(22) PCT Filed: Mar. 12, 2021
(86) PCT No.: PCT/JP2021/009990

§ 371 Date: Sep. 6, 2023

(51) Int. Cl. G06Q 10/0835

(52) U.S. Cl. CPC G06Q 10/08355

(57) ABSTRACT

An information provision system according to an aspect of the present disclosure includes: at least one memory configured to store instructions; and at least one processor configured to execute the instructions to: acquire a time period in which a parking space of a subscriber of a scheduled delivery service is available; and determine, from among parking spaces for which the time period is acquired, a parking space to be used to make delivery by a business entity providing the scheduled delivery service.

### TECHNICAL FIELD

The present disclosure relates to an information provision system and the like.

### BACKGROUND ART

There is a service business that provides subscribers with regular delivery of foods and the like. The purchase is usually delivered periodically using a vehicle such as a truck. For example, the delivery to the subscriber is performed at a fixed time of a fixed day of the week.

As a technique related to the present disclosure, PTL 1 discloses a delivery route creation device that requests reservation of a parking space near a delivery destination.

### CITATION LIST

### Patent Literature

PTL 1: JP 2020-052836 A

### SUMMARY OF INVENTION

### Technical Problem

In a case where delivery is made using a truck, the deliverer parks the truck in a parking space and carries baggage to each delivery destination. However, the parking space is often limited, and the truck may not be parked near the delivery destination. In such a case, the deliverer has to park the truck in an available parking space far from the delivery destination and walk to the delivery destination. In particular, although parking spaces are limited in urban areas, the number of delivery destinations is large because there are many residents. Therefore, a lot of walking between a far parking space and delivery destinations may occur.

The delivery route creating device of PTL 1 uses a parking spaces such as coin-operated parking, a public facility with parking spaces, or parking spaces available on streets such as time limit parking sections. Since the deliverer has to compete with other vehicles for parking spaces in these parking areas, a parking space cannot be secured at a delivery destination in some cases.

The present disclosure provides an information provision system capable of stably securing a parking space used to make delivery.

### Solution to Problem

The information provision system according to the present disclosure includes an acquisition means that acquires a time period in which a parking space of a subscriber of a scheduled delivery service is available, and a determination means that determines, from among parking spaces for which the time period is acquired, a parking space to be used to make delivery by a business entity providing the scheduled delivery service.

An information provision method according to the present disclosure includes acquiring a time period in which a parking space of a subscriber of a scheduled delivery service is available, and determining, from among parking spaces for which the time period is acquired, a parking space to be used to make delivery by a business entity providing the scheduled delivery service.

A recording medium according to the present disclosure non-transiently stores a program that causes a computer to execute a process including acquiring a time period in which a parking space of a subscriber of a scheduled delivery service is available, and determining, from among parking spaces for which the time period is acquired, a parking space to be used to make delivery by a business entity providing the scheduled delivery service.

### Advantageous Effects of Invention

According to the present disclosure, a parking space used for delivery can be stably secured.

### BRIEF DESCRIPTION OF DRAWINGS

FIG. 1 is a block diagram illustrating a configuration of an information provision system 100 according to a first example embodiment.

FIG. 2 is a diagram illustrating an example of user information.

FIG. 3 is a block diagram illustrating a configuration example of a deliverer terminal.

FIG. 4 is a block diagram illustrating a configuration example of a user terminal 12.

FIG. 5 is a flowchart illustrating an operation example of the information provision system 100 according to the first example embodiment.

FIG. 6 is a block diagram illustrating a configuration of an information provision system 100 according to a second example embodiment.

FIG. 7 is a flowchart illustrating an operation example of the information provision system 100 according to the second example embodiment.

FIG. 8 is a block diagram illustrating an example of a hardware configuration of a computer 500.

### EXAMPLE EMBODIMENTS

### First Example Embodiment

An aspect of an example embodiment of the present disclosure will be described by taking, as an example, determination of a parking space used when a business entity providing a scheduled delivery service makes delivery to subscribers of the delivery service. The subscriber is an example of a user who receives scheduled delivery. At least some of the subscribers offer a parking space to be used by a deliverer for delivery. The subscriber may offer a parking space in such a way that the deliverer can use the parking space for delivery to another subscriber. Further, the subscriber may offer a parking space in such a way that the deliverer can use the parking space for delivery to a non-subscriber. The non-subscriber does not receive regular deliveries. Note that the present disclosure is not limited to application to a delivery service to a subscriber of a business entity that provides a scheduled delivery service.

A supporter who is not a subscriber and cooperates with an activity of a business entity that provides a scheduled delivery service is referred to as a support member. The support member can offer a parking space to be used to make a delivery, like the subscribers. The subscriber and the support member are hereinafter also simply referred to as a user.

The subscriber may temporarily stop the delivery or change the delivery date or the delivery time, and in this case, the subscriber is also included in the user who receives the scheduled delivery. A user who performs trial use of delivery (one-time membership) or a user who receives delivery when necessary without determining a scheduled delivery date may be included in the subscriber.

(Configuration)

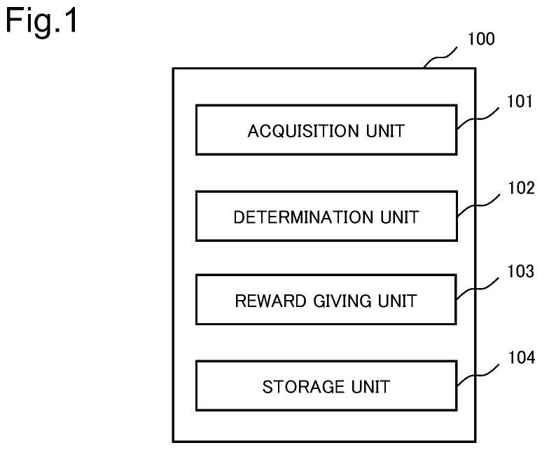

FIG. 1 is a block diagram illustrating a configuration of an information provision system 100 according to a first example embodiment. The information provision system 100 includes an acquisition unit 101, a determination unit 102, a reward giving unit 103, and a storage unit 104.

The information provision system 100 is connected to a deliverer terminal 11 and a user terminal 12 via a network. The deliverer terminal 11 and the user terminal 12 may be, for example, a mobile terminal, a smartphone, a tablet, a personal computer, a wearable terminal, or other terminals. The user terminal 12 may include a display means such as a display, and the user terminal 12 may be connected to the display means to communicate in a wired or wireless manner.

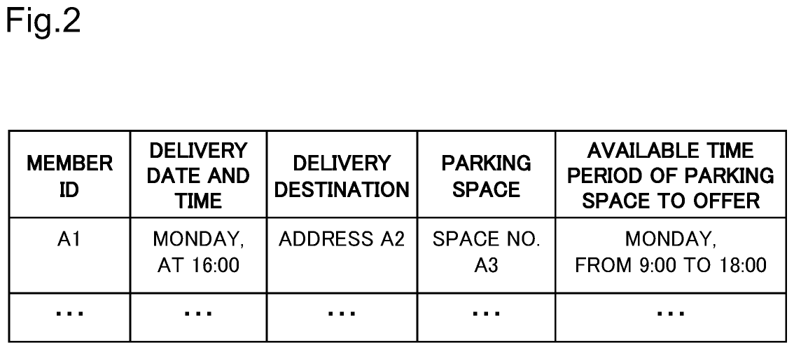

The storage unit 104 stores user information. FIG. 2 is a diagram illustrating an example of the user information. The user information includes delivery date and time, delivery destination, parking space location, and available time of the parking space for each user identifier (ID). The user ID is an identifier that uniquely identifies the subscriber or the support member. The user ID may not include any of the delivery date and time, the delivery destination, the parking space location, and the available time of the parking space. This is because some users do not receive deliveries and some users do not provide a parking space.

The delivery date and time is a date and time or a time period when the deliverer is scheduled to arrive at the delivery destination. The delivery date and time may be, for example, a date and time when scheduled delivery to the subscriber is performed, such as “around 16:00 every Monday”. The delivery date and time may be set at the time of contract for scheduled delivery. The delivery date and time may include a desired delivery time of the subscriber appropriately set according to the subscriber's preference. Alternatively, the same date may be appropriately set for a plurality of nearby subscribers as the delivery date and time. The delivery destination is location information such as an address.

The parking space location includes information for specifying a parking space provided by the user. The parking space provided by the user may be a parking space next to residence, a space in front of the residence where parking is possible, or a parking space owned by the user separately from the residence. The parking space next to the residence may be, for example, a section of parking lots provided next to an apartment with lines drawn on the ground. For example, the information for specifying the parking space may be a space number of the parking space provided together with the delivery destination address or other location information. The available time of the parking space is a time period during which the user can offer the parking space.

For example, the acquisition unit 101 acquires a time period in which the user can offer a parking space from the user terminal 12. The acquisition unit 101 may store the acquired information in the storage unit 104. The acquisition unit 101 acquires a time period in which the user can provide the parking space before the deliverer starts the delivery.

The acquisition unit 101 acquires a time period in which the parking space of the subscriber of the scheduled delivery service can be used. The time period in which the parking space is available is a time period in which the user can provide the parking space to the deliverer. In other words, the acquisition unit 101 acquires a time period in which the subscriber can provide the parking space.

In particular, the acquisition unit 101 may acquire a time period in which the parking space of the subscriber is available on the delivery date of the subscriber. In other words, the subscriber offers a parking space on a day when delivery is scheduled. However, the acquisition unit 101 may acquire a time period in which the subscriber can provide a parking space on other days when delivery to the subscriber is not scheduled.

The acquisition unit 101 may further acquire a time period in which a parking space of a supporter of the business entity providing a scheduled delivery service is available. In other words, the support member may also provide a parking space.

For example, the acquisition unit 101 may transmit a provision request to the user terminal 12 of the user registered in the user information. The provision request includes information indicating at least one of a date, a time, and a day of the week when a parking space is needed. The acquisition unit 101, for example, may transmit the provision request preferentially to a user who has scheduled delivery. The provision request may include a delivery notice to the user who receives the delivery. The delivery notice includes at least a date when delivery to the user is to be made.

The determination unit 102 determines a parking space to be used to make a delivery by the business entity providing the scheduled delivery service from among the parking spaces in which the available time periods have been acquired. The determination unit 102 may determine the parking space in such a way that the parking space of the user is used on the delivery date of the user offering the parking space.

For example, the determination unit 102 refers to the storage unit 104 and determines a parking space which is available at the delivery date and time indicated in the user information and which is near the delivery destination as a parking space to be used. In a case where a plurality of parking spaces is available, the determination unit 102 may determine a parking space closer to the delivery destination as the parking space to be used.

The determination unit 102 generates a usage plan indicating the determined parking space. The usage plan is, for example, a list of one or more parking spaces to be used by the deliverer on the delivery date.

For example, the determination unit 102 determines a parking space to be used before the deliverer starts delivery, and distributes a usage plan of parking spaces to the deliverer. Preferably, the determination unit 102 generates the usage plan by the day before the delivery is performed. Since the determination unit 102 determines the parking space to be used in advance, it is possible to perform efficient delivery as compared with a case where the deliverer performs delivery while searching for a parking space on the delivery date. In addition, since it is not necessary to search for a parking space on the delivery date, it is possible to perform delivery according to the delivery date and time stored in the storage unit 104.

The determination unit 102 may determine a plurality of parking spaces and distribute the parking spaces to the deliverer. The deliverer may select one of the parking spaces determined by the determination unit 102 to use. The determination unit 102 may generate the usage plan based on the selected parking space.

Furthermore, in addition to the usage plan of the parking spaces, the determination unit 102 may further determine the delivery plan including at least one of the use time of the parking space, the delivery route, and the sequential order of deliveries.

The use time of the parking space is, for example, a time at which the use of the parking space is scheduled to start and a time at which the use of the parking space is scheduled to end. For example, the determination unit 102 calculates the scheduled delivery time based on a predetermined time for one delivery and the number of delivery destinations, and determines the use time of the parking space based on the calculated time. For example, the determination unit 102 may further trace parking spaces and delivery destinations stored in the user information on map data, calculate a travel time between each parking space and each delivery destination using an existing technology, and determine the use time of the parking spaces based on the calculated travel time.

The delivery route is, for example, a map indicating a route to each parking space or each delivery destination. The delivery route may indicate that a route from the determined parking space to a predetermined delivery destination. For example, the determination unit 102 traces the parking spaces and the delivery destinations stored in the user information on the map data, and indicates a route in which the distance between each parking space and each delivery destination becomes the shortest using the existing technology.

The sequential order of deliveries is, for example, a map indicating the sequential order of each delivery destination to go to. For example, the sequential order of deliveries may be indicated by tracing numbers to the parking spaces or delivery destinations on the map of the delivery route described above. With this configuration, the sequential order that makes the distance to each delivery destination becomes the shortest can be indicated. The delivery order may be a list of delivery destinations indicating the order obtained from the delivery route.

The delivery plan may indicate a route from one parking space to a plurality of delivery destinations.

The delivery plan may include a plan for non-scheduled delivery to a delivery destination, such as delivery to a non-subscriber. In addition, the delivery plan may also indicate a route to a delivery destination of a subscriber who has not placed an order for receiving the delivery. The deliverer collects, for example, a container used for a previous delivery, an order slip for a next delivery, and the like from the subscriber who has not currently placed an order.

The determination unit 102 may group some of the plurality of delivery destinations on that day to determine the parking space to be used. The determination unit 102 may determine a parking space in which the total of the distances from the parking space to each of the grouped delivery destinations or the total of the estimated times is the smallest.

In a case where the stored delivery date and time is the desired delivery time of the subscriber, the determination unit 102 may determine the delivery plan based on the desired delivery time of the subscriber in addition to the time period in which the parking space of the subscriber acquired by the acquisition unit 101 is available.

In a case where both the subscriber's parking space and the support member's parking space are available, the determination unit 102 may determine to preferentially use the subscriber's parking space.

The determination unit 102 may transmit a use plan notification of the parking space to the provider of the parking space based on the determined usage plan. The use plan notification of the parking space indicates that the deliverer uses the parking space on a specific day. The provider of the parking space is a subscriber or a support member, and is a user whose available time period of the parking space has been acquired.

In a case where the delivery plan includes the use time of the parking space, the determination unit 102 may notify the provider of the parking space use time based on the delivery plan together with the use plan notification. The determination unit 102 may transmit the use plan notification and the parking space use time only to the user whose parking space is determined to be use. In a case where the delivery plan includes the delivery order, the determination unit 102 may notify, based on the delivery plan, the subscriber at the delivery destination of what number in the delivery sequential order among the deliveries on that day the deliver is going to be made.

The reward giving unit 103 gives a reward to a provider of a parking space in response to offering of the parking space. For example, when the deliverer uses the parking space, the reward giving unit 103 gives a reward to the provider whose parking has been used. The reward giving unit 103 may give a reward according to the length of time during which the deliverer uses the parking space. The reward giving unit 103 may give a reward when the user inputs the providable time. By giving rewards, more support members who provide a parking space are expected as compared with a case where no reward is given. In addition, it can be expected that the number of new subscribers increases. Further, the loyalty of the subscribers can be improved by giving rewards.

The reward to be given is not particularly limited, and may be, for example, cash, electronic money, gift certificates, event tickets, products, free samples, reward points, coupons, or the like. The reward points and coupons may be given in the delivery service provided by the business entity providing the scheduled delivery service or in a business such as a store that is different from the delivery service. If the reward points or the coupons that can be used for a joint purchase are given to a person who is not a subscriber of the business entity providing the scheduled delivery service, it encourages the person to be a subscriber.

The reward giving unit 103 may notify the provider of the parking space of given rewards.

<Configuration of Deliverer Terminal 11>

The deliverer terminal 11 is a terminal used by the deliverer who makes delivery to users. The deliverer terminal 11 may be prepared by the number of deliverers.

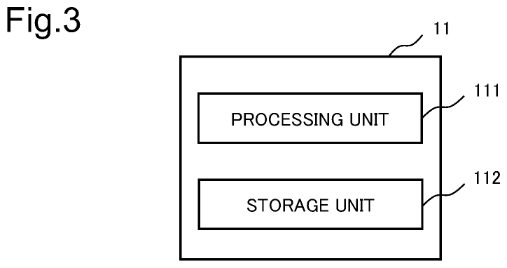

FIG. 3 is a block diagram illustrating a configuration example of the deliverer terminal 11. The deliverer terminal 11 includes a processing unit 111 and a storage unit 112. The following functions of the processing unit 111 may be implemented by installing an application program in the storage unit 112. The processing unit 111 may not have some of the following functions.

The processing unit 111 receives the determined delivery plan from the information provision system 100 and displays the delivery plan on the screen of the deliverer terminal 11. The deliverer makes delivery based on the delivery plan. When the information provision system 100 determines a plurality of parking spaces, the processing unit 111 may selectively display the plurality of parking spaces. The processing unit 111 may display the parking spaces offered by the subscribers differently from the parking spaces offered by other users.

The processing unit 111 may execute processing of registering the completion of the delivery by the operation of the deliverer. Furthermore, the processing unit 111 may execute processing of registering the usage status of the parking space. The usage status of the parking space indicates, for example, whether the parking space is occupied, or the start and end of the use. The processing unit 111 may automatically register the usage status of the parking space based on location information of a global positioning system (GPS) of the deliverer terminal 11. The processing unit 111 transmits the registered usage status of the parking space to the information provision system 100.

<Configuration of User Terminal 12>

The user terminal 12 is a terminal used by a user including a subscriber or a support member.

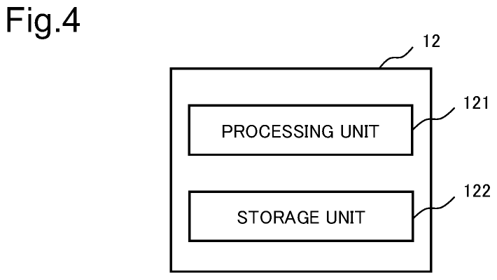

FIG. 4 is a block diagram illustrating a configuration example of the user terminal 12. The user terminal 12 includes a processing unit 121 and a storage unit 122. The following functions of the processing unit 121 may be achieved by installing an application program in the storage unit 122. The processing unit 121 may not have some of the following functions. The application program may be provided by the business entity that provides the scheduled delivery service.

The processing unit 121 executes a reception process of receiving an input of a time period in which the user can offer the parking space. In the reception process, the processing unit 121 may further receive an input of an order of a product from the subscriber at the delivery destination. The processing unit 121 may receive an input of a time period in which the subscriber can offer a parking space from delivery dates of the order of the subscriber. The processing unit 121 executes a transmission process of transmitting the received information to the information provision system 100.

Furthermore, the processing unit 121 executes a process of receiving the use plan notification of the parking space of the user from the information provision system 100. The processing unit 121 displays the received use plan notification on the screen of the user terminal 12. The use plan notification of the parking space indicates that the deliverer uses the parking space on a specific day. The processing unit 121 may further receive the parking space use time (the time at which the deliverer is scheduled to use the parking space among the time periods in which the user can offer the parking space) based on the delivery plan from the information provision system 100 and display the parking space use time on the screen.

The processing unit 121 may further receive the parking space usage status indicating the time when the deliverer actually uses the parking space, and display the parking space usage status on the screen.

Furthermore, the processing unit 121 may receive a notification of a given reward and display the notification on the screen.

(Operation)

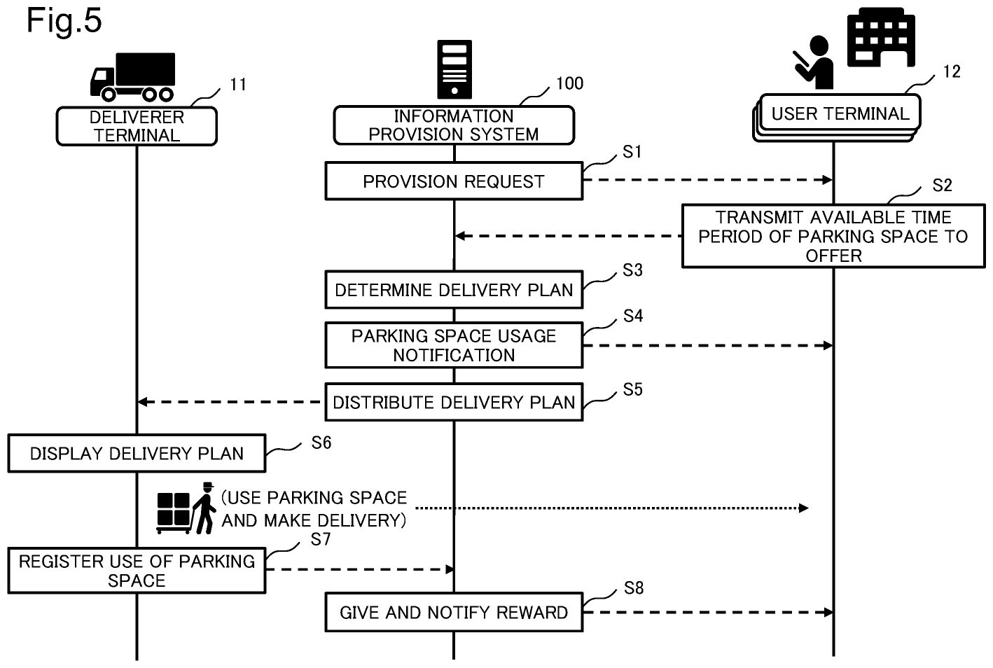

FIG. 5 is a flowchart illustrating an operation example of the information provision system 100 according to the first example embodiment. First, the acquisition unit 101 of the information provision system 100 transmits a parking space provision request to the user terminal 12 (step S1).

The processing unit 121 of the user terminal 12 receives an input of a time period in which the parking space can be offered and transmits the information to the information provision system 100 (step S2). The acquisition unit 101 of the information provision system 100 acquires a time period in which the parking space of the user is available and stores the time period in the storage unit 104.

The determination unit 102 determines the delivery plan based on the acquired time period (step S3). Next, the determination unit 102 notifies the user offering the parking space of the parking space use time period based on the delivery plan (step S4). Further, the determination unit 102 distributes the delivery plan to the deliverer terminal 11 (step S5).

The deliverer terminal 11 displays the delivery plan (step S6), and the deliverer makes delivery using the parking space. Specifically, the deliverer parks the vehicle in the parking space and carries a package to the delivery destination. The deliverer terminal 11 registers the usage status of the parking space (step S7) and transmits the usage status to the information provision system 100.

The reward giving unit 103 gives a reward to the user terminal 12 of the user who has offered the parking space according to the usage status of the parking space received from the deliverer terminal 11 and notifies the user terminal of the given reward (step S8). The user terminal 12 that has received the notification of the given reward displays the notification on the display means.

The operation example of the information provision system 100 according to the first example embodiment has been described.

(Effects)

According to the first example embodiment, a parking space used for delivery can be stably secured. The reason is that the acquisition unit 101 acquires time periods in which parking spaces of subscribers of the scheduled delivery service are available, and the determination unit 102 determines a parking space to be used for delivery by the business entity providing the schedule delivery service from the parking spaces of the subscribers. Further, the reason is that the acquisition unit 101 acquires time periods in which subscribers can offer parking spaces from delivery dates to the subscribers of the business entity providing the scheduled delivery service, and the determination unit 102 determines a parking space used for delivery on the delivery date.

In addition, according to the first example embodiment, the parking space to be used is easily determined as compared with the case of using coin-operated parking or another parking reservation system. Since it is known that the parking space is used for delivery, the user can offer a parking space with a sense of security as compared with a case where the parking space is lent without limiting the use purpose of the parking space. In particular, in a case where the business entity that provides the scheduled delivery service is based on the spirit of cooperation, a subscriber would like to offer a parking space to help the subscribers in such a way that the parking space to be used is easily determined.

Then, it is assumed that the parking space offered by the subscriber at the delivery destination is close to the delivery destination. Therefore, a parking space close to the delivery destination can be secured, and the deliverer can efficiently make delivery.

Furthermore, according to the first example embodiment, efficient delivery from the parking space of the user to a plurality of delivery destinations can be performed. The reason is that the delivery plan may indicate that the deliverer goes to a plurality of delivery destinations from one parking space. It is assumed that the parking space offered by the subscriber is close to the delivery destinations of other subscribers.

If a parking space close to the delivery destination can be stably secured, there is an effect that the subscriber can receive the delivery as planned.

### Second Example Embodiment

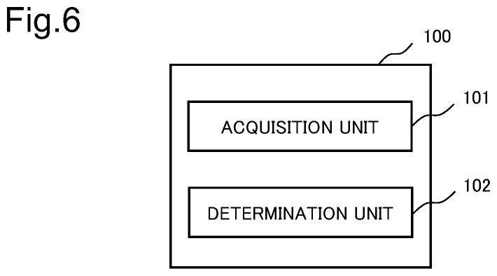

In a second example embodiment, a basic configuration of the first example embodiment will be described. FIG. 6 is a block diagram illustrating a configuration of an information provision system 100 according to the second example embodiment. The information provision system 100 according to the second example embodiment includes an acquisition unit 101 and a determination unit 102.

The acquisition unit 101 acquires a time period in which the parking space of the subscriber of the scheduled delivery service can be used. The available time periods of parking spaces are time periods when the subscribers can offer parking spaces to the business entity providing the scheduled delivery service. The determination unit 102 determines a parking space used for delivery by the business entity providing the scheduled delivery service from the parking spaces that the time periods when the parking spaces are available have been acquired.

The scheduled delivery includes, for example, delivery with a fixed delivery date such as “the first day of each month” and “the first and third Mondays of each month”. In addition, the scheduled delivery may include delivery with a fixed delivery date and time, such as “around 16:00 every Monday”. Further, the scheduled delivery may include a delivery whose number of deliveries is determined during a predetermined period of time, such as “one user-determined day every month” or “two or more times per week”.

In particular, the acquisition unit 101 may acquire a time period when the parking space of the subscriber is available in the delivery date set for the subscriber. However, the acquisition unit 101 may acquire a time period in which the subscriber can provide a parking space on other days when delivery to the subscriber is not scheduled.

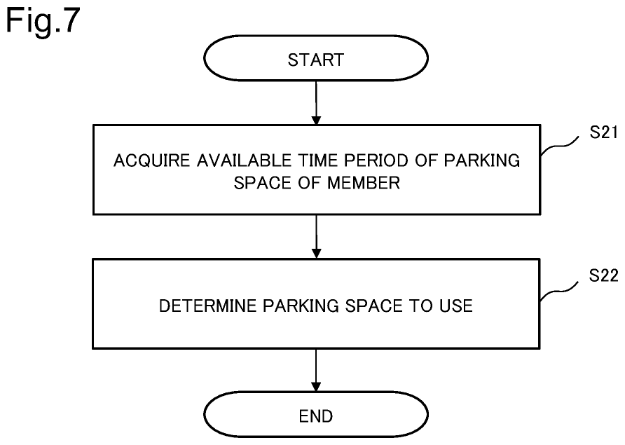

FIG. 7 is a flowchart illustrating an operation example of the information provision system 100 according to the second example embodiment. First, the acquisition unit 101 acquires available time periods of parking spaces offered by subscribers of the scheduled delivery service (step S21). Next, the determination unit 102 determines a parking space to be used to make a delivery by the business entity providing the scheduled delivery service from the parking spaces that the available time periods have been acquired (step S22).

According to the second example embodiment, a parking space used for delivery can be stably secured. The reason is that the acquisition unit 101 acquires the available time periods of the parking spaces offered by the user who receives the scheduled delivery, and the determination unit 102 determines a parking space to be used for the scheduled delivery from the parking spaces that the available time periods have been acquired.

### Modified Example

Each of the above-described example embodiments can be modified, for example, as described in the following modification examples.

### (Modification Example 1) Adjustment of Delivery Date and Time

In the first example embodiment, the case where the determination unit 102 determines a delivery plan according to the stored delivery date and time has been described. However, the delivery date and time may be adjustable according to the usage plans of the parking spaces. For example, in a case where there is no parking space available for delivery to a certain delivery destination in the morning, and there is a parking space available in the afternoon, the determination unit 102 may determine a delivery plan for delivery to the delivery destination in the afternoon.

The determination unit 102 may notify the user at each delivery destination of the scheduled delivery time based on the determined delivery plan. Preferably, the determination unit 102 notifies the user at the delivery destination of the scheduled delivery time by the day before the delivery date. The user terminal 12 may display the scheduled delivery time on the display means.

For example, the determination unit 102 may determine and notify a time more detailed than the delivery date and time stored in advance. Alternatively, the determination unit 102 may determine and notify a time earlier than or later than the delivery date and time stored in advance.

Depending on the determined delivery plan, delivery may not be performed according to the delivery date and time stored in advance in the storage unit 104. However, the user who receives the scheduled delivery may be anxious if the deliverer does not arrive at the usual time. In a case where the scheduled delivery time comes earlier or later than the user time due to the availability of the parking space or an increase or decrease in the number of delivery destinations, the user at the delivery destination can feel relieved by being contacted in advance. This can also reduce inquiries to the deliverer when the delivery time is delayed.

The determination unit 102 may notify the user in a case where the scheduled delivery time is earlier or later than the delivery date and time stored in advance by a predetermined time length or more. The determination unit 102 may notify each delivery destination of the number of the delivery sequential order on the delivery date instead of the scheduled delivery time.

### (Modified Example 2) Application to Another Delivery Service

The present disclosure can be applied to other delivery services in addition to the delivery service to subscribers of business entities that provide the scheduled delivery service. Each of the user who receives the delivery and the user who provides a parking space may be a user of the delivery service. Regarding the user, user information is stored in the storage unit 104 as a subscriber of the delivery service. The users of the delivery service provide parking spaces.

Even in a case where there is no user who receives scheduled delivery, the information provision system 100 may generate a parking space to be used or a delivery plan every day or every time. In this case, the acquisition unit 101 of the information provision system 100 acquires the available time period of the parking spaces of the users of the delivery service, and the determination unit 102 determines a parking space used for the delivery from the available parking spaces. The acquisition unit 101 may acquire available times of the parking spaces of the users who have scheduled delivery on the scheduled delivery dates.

### (Modification Example 3) Case where Plural Parking Spaces are Available

There may be a case where two or more parking spaces close to each other are offered by a plurality of users, and efficient delivery is possible using either parking space. In this case, the determination unit 102 may determine the parking space in such a way that the number of times of use or time of the parking space is balanced among the plurality of users. Since the parking space is determined in such a way that the use of the parking space is balanced, the reward giving unit 103 can ensure fairness between the users when giving rewards.

### (Modification Example 4) Case where there is No Available Parking Space

In the first example embodiment, the case where the acquisition unit 101 transmits the provision request to the users who are likely to offer parking spaces has been described. However, the acquisition unit may not transmit the provision request. The user can input available times of the parking space without a provision request. The acquisition unit 101 may make the provision request only when there is no available parking space necessary for the delivery date.

It is assumed that another vehicle is parked in the parking space when the deliverer arrives at the parking space by the vehicle. In a case where the parking space indicated in the delivery plan is not vacant, the deliverer may notify the information provision system 100 using the deliverer terminal 11. The information provision system 100 that has received the notification may contact the user and askes for the parking space. Alternatively, the deliverer may transmit a request for changing the delivery plan to the information provision system 100 using the deliverer terminal 11, and the determination unit 102 may change the delivery plan in such a way as to use a parking space of another user.

Note that, in a case where there is no offer of parking spaces from the users, the acquisition unit 101 may further acquire a vacancy status of coin-operated parking, public facilities with parking spaces, parking spaces on streets such as a time limit parking section, or the like. The determination unit 102 may determine the use of these parking spaces based on the availability.

[Hardware Configuration]

In each of the above-described example embodiments, each component (the acquisition unit 101, the determination unit 102, the reward giving unit 103, and the storage unit 104) of the information provision system 100 indicates a block of a functional unit. Some or all of each component of each device may be achieved by an arbitrary combination of a computer 500 and programs.

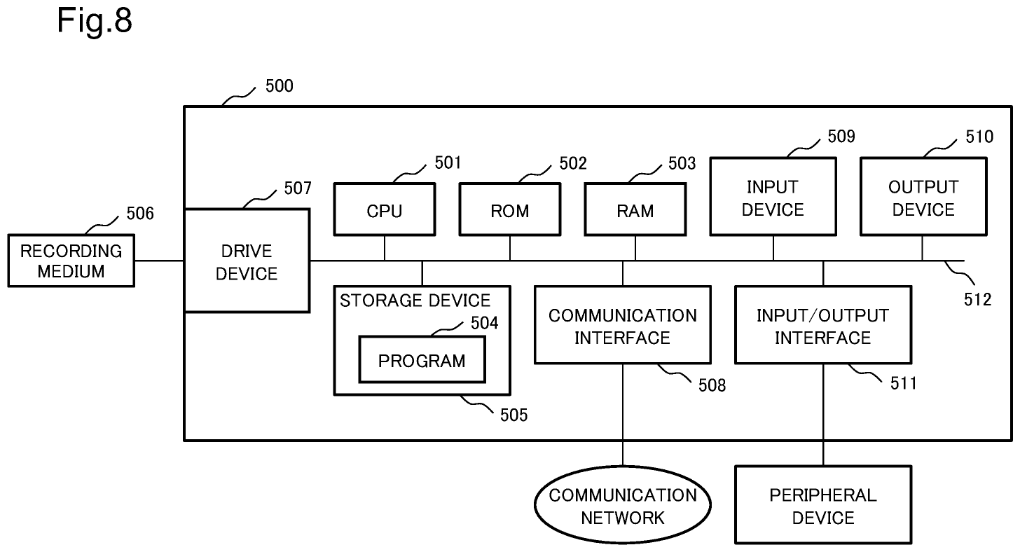

FIG. 8 is a block diagram illustrating an example of a hardware configuration of the computer 500. Referring to FIG. 8, the computer 500 includes, for example, a central processing unit (CPU) 501, a read only memory (ROM) 502, a random access memory (RAM) 503, a program 504, a storage device 505, a drive device 507, a communication interface 508, an input device 509, an input/output interface 511, and a bus 512.

The program 504 includes an instruction for achieving each function of each device. The program 504 is stored in advance in the ROM 502, the RAM 503, and the storage device 505. The CPU 501 achieves each function of each device by executing instructions included in the program 504. For example, the CPU 501 of the information provision system 100 executes instructions included in the program 504 to implement the functions of the information provision system 100. Furthermore, the RAM 503 may store data to be processed in each function of each device. For example, the user information in the information provision system 100 or the delivery plan may be stored in the RAM 503 of the computer 500.

The drive device 507 reads and writes data in a recording medium 506. The communication interface 508 provides an interface with a communication network. The input device 509 is, for example, a mouse, a keyboard, or the like, and receives an input of information from an administrator, a deliverer, or the like of the information provision system 100. The output device 510 is, for example, a display, and outputs (displays) information to an administrator, a deliverer, or the like. The input/output interface 511 provides an interface with a peripheral device. The bus 512 connects the respective components of the hardware. The program 504 may be supplied to the CPU 501 via a communication network, or may be stored in the recording medium 506 in advance, read by the drive device 507, and supplied to the CPU 501.

The hardware configuration illustrated in FIG. 8 is an example, and other components may be added or some components may not be included.

There are various modifications of the implementation method of each device. For example, each device may be achieved by an arbitrary combination of a computer and a program different for each component. In addition, a plurality of components included in each device may be achieved by an arbitrary combination of one computer and a program.

In addition, some or all of the components of each device may be achieved by general-purpose or dedicated circuitry including a processor or the like, or a combination of those circuitries. These circuitries may be configured by a single chip or may be configured by a plurality of chips connected via a bus. Some or all of each component of each device may be achieved by a combination of the above-described circuitry or the like and a program.

In addition, in a case where some or all of each component of each device is achieved by a plurality of computers, circuits, and the like, the plurality of computers, circuitries, and the like may be arranged in a centralized manner or in a distributed manner.

Furthermore, at least a part of the information provision system 100 may be provided in a software as a service (SaaS) format. In other words, at least a part of the functions for realizing the information provision system 100 may be executed by software executed via a network.

While the present disclosure has been particularly shown and described with reference to exemplary embodiments thereof, the present disclosure is not limited to these embodiments. It will be understood by those of ordinary skill in the art that various changes in form and details may be made therein without departing from the spirit and scope of the present disclosure as defined by the claims. In addition, the configurations in the respective example embodiments can be combined with each other without departing from the scope of the present disclosure.

Some or all of the above example embodiments can be described as the following supplementary notes, but are not limited to the following.

[Supplementary Note 1]

An information provision system including:
an acquisition means configured to acquire a time period in which a parking space of a subscriber of a scheduled delivery service is available; and
a determination means configured to determine, from among parking spaces for which the time period is acquired, a parking space to be used to make delivery by a business entity providing the scheduled delivery service.

[Supplementary Note 2]

An information provision system including:
an acquisition means configured to acquire a time period in which a parking space of a subscriber is available, on a delivery date when the subscriber receives a delivery from a business entity providing a scheduled delivery service; and
a determination means configured to determine, from among parking spaces for which the time period is acquired, a parking space to be used to make delivery on the delivery date.

[Supplementary Note 3]

The information provision system according to supplementary note 1 or 2 in which
the acquisition means further acquires a time period in which a parking space of a supporter of the business entity is available.

[Supplementary Note 4]

The information provision system according to any one of supplementary notes 1 to 3 in which
the determination means further determines a delivery plan including at least any one of a parking space use time, a delivery route, and a sequential order of deliveries.

[Supplementary Note 5]

The information provision system according to supplementary note 4 in which
the determination means notifies the subscriber at each delivery destination of an estimated delivery time based on the delivery plan.

[Supplementary Note 6]

The information provision system according to supplementary note 4 or 5 in which
the determination means notifies a provider of the parking space of a use time period in which the parking space is to be used based on the delivery plan.

[Supplementary Note 7]

The information provision system according to any one of supplementary notes 1 to 6 in which
the determination means further determines a use of the parking space based on a desired delivery time of the subscriber.

[Supplementary Note 8]

The information provision system according to any one of supplementary notes 1 to 7 further including
a reward giving unit that gives a reward to the provider of the parking space according to offering of the parking space.

[Supplementary Note 9]

The information provision system according to any one of supplementary notes 1 to 8 in which the determination means determines a parking space close to the delivery destination as the parking space to be used from among the plurality of parking spaces.

[Supplementary Note 10]

An information provision method including:
acquiring a time period in which a parking space of a subscriber of a scheduled delivery service is available; and
determining, from among parking spaces for which the time period is acquired, a parking space to be used to make delivery by a business entity providing the scheduled delivery service.

[Supplementary Note 11]

An information provision method including:
acquiring a time period in which a parking space of a subscriber is available, on a delivery date when the subscriber receives delivery from a business entity providing a scheduled delivery service; and
determining, from among parking spaces for which the time period is acquired, a parking space to be used to make delivery on the delivery date.

[Supplementary Note 12]

A recording medium non-temporarily storing a program that causes a computer to execute a process including:
acquiring a time period in which a parking space of a subscriber of a scheduled delivery service is available; and
determining, from among parking spaces for which the time period is acquired, a parking space to be used to make delivery by a business entity providing the scheduled delivery service.

[Supplementary Note 13]

A recording medium non-temporarily storing a program that causes a computer to execute a process including:
acquiring a time period in which a parking space of a subscriber is available, on a delivery date when the subscriber receives delivery from a business entity providing a scheduled delivery service; and
determining, from among parking spaces for which the time period is acquired, a parking space to be used to make delivery on the delivery date.

[Supplementary Note 14]

A recording medium non-temporarily storing a program that causes a user terminal to execute a process including:
accepting, from a subscriber of a scheduled delivery service, an input of a product order and a time period, on a delivery date of the order of the subscriber, in which the subscriber can offer a parking space to a business entity providing the scheduled delivery service; and
displaying a use plan notification of the parking space determined based on the time period.

### REFERENCE SIGNS LIST

100 information provision system
101 acquisition unit
102 determination unit
103 reward giving unit
104 storage unit
11 deliverer terminal
111 processing unit
112 storage unit
12 user terminal
121 processing unit
122 storage unit

What is claimed is:

1. An information provision system comprising:
at least one memory configured to store instructions; and
at least one processor configured to execute the instructions to:
acquire time period information indicating a time period in which a parking space of a subscriber of a scheduled delivery service is available; and
determine, from among parking spaces for which the time period information is acquired, a parking space to be used to make delivery by a business entity providing the scheduled delivery service.

2. (canceled)

3. The information provision system according to claim 1, wherein the at least one processor is further configured to execute the instructions to:
acquire time period information indicating a time period in which a parking space of a supporter of the business entity is available.

4. The information provision system according to claim 1, wherein the at least one processor is further configured to execute the instructions to:
determine a delivery plan including at least any one of a parking space use time, a delivery route, and a sequential order of deliveries.

5. The information provision system according to claim 4, wherein the at least one processor is further configured to execute the instructions to:
notify the subscriber at each delivery destination of an estimated delivery time based on the delivery plan.

6. The information provision system according to claim 4, wherein the at least one processor is further configured to execute the instructions to:
notify a provider of the parking space of a use time period in which the parking space is to be used based on the delivery plan.

7. The information provision system according to claim 1, wherein the at least one processor is further configured to execute the instructions to:
determine a use of the parking space based on a desired delivery time of the subscriber.

8. The information provision system according to claim 1, wherein the at least one processor is further configured to execute the instructions to:
give a reward to the provider of the parking space according to offering of the parking space.

9. The information provision system according to claim 1, wherein the at least one processor is further configured to execute the instructions to:
determine a parking space close to the delivery destination as the parking space to be used from among the plurality of parking spaces.

10. An information provision method comprising:
acquiring time period information indicating a time period in which a parking space of a subscriber of a scheduled delivery service is available; and
determining, from among parking spaces for which the time period information is acquired, a parking space to be used to make delivery by a business entity providing the scheduled delivery service.

11. (canceled)

12. A recording medium non-temporarily storing a program that causes a computer to execute a process comprising:
acquiring time period information indicating a time period in which a parking space of a subscriber of a scheduled delivery service is available; and
determining, from among parking spaces for which the time period information is acquired, a parking space to be used to make delivery by a business entity providing the scheduled delivery service.

13-14. (canceled)
